(19) United States
(12) Patent Application Publication
(10) Pub. No.: US 2006/0050117 A1
(43) Pub. Date: Mar. 9, 2006

(54) Image recording process, image recording apparatus and liquid composition

(75) Inventors: Koichi Sato, Atsugi-shi (JP); Ikuo Nakazawa, Zama-shi (JP); Ryuji Hogashi, Atsugi-shi (JP); Sakae Suda, Sagamihara-shi (JP); Masayuki Ikegami, Atsugi-shi (JP); Keiichiro Tsubaki, Kawasaki-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/543,178

(22) PCT Filed: Sep. 21, 2004
(86) PCT No.: PCT/JP04/14132

§ 371 Date: Jul. 22, 2005

(30) Foreign Application Priority Data
Sep. 6, 2003 (JP) 2003-335855
Sep. 14, 2004 (JP) 2004-266981

(51) Int. Cl. G01D 11/00

(52) U.S. Cl. 347/100

(57) ABSTRACT

Disclosed herein is an image recording process for recording an image on a recording medium, which comprises the step of recording the image on the recording medium with an ink, and applying a liquid composition comprising an amphiphilic block copolymer and a solvent to at least one of a region in which the image has been recorded with the ink and a region in which no image is recorded with the ink.

### TECHNICAL FIELD

The present invention relates to an image recording process, an image recording apparatus and a liquid composition, by which fixing ability and weather fastness are improved.

### BACKGROUND ART

In recent years, digital printing technology has been vigorously developed. Typical examples of this digital printing technology include those called electrophotographic technology and ink-jet technology, and importance of its existence as image-forming technology in homes and offices has more and more increased in recent years.

Among these, the ink-jet technology has a great feature as a directly recording method that it is compact and low in consumption power. Improvement toward higher quality images is also quickly advanced by formation of micro-nozzles, or the like. An example of the ink-jet technology is a method that an ink fed from an ink tank is heated by a heater in a nozzle to evaporate and bubble the ink, thereby ejecting the ink to form an image on a recording medium. Another example is a method that an ink is ejected from a nozzle by vibrating a piezoelectric element.

Since aqueous dye solutions are generally used as inks used in these ink-jet methods, in some cases, bleeding may occur when inks of different colors overlap with each other, or a phenomenon called feathering may appear in a direction of fibers in paper at a recorded portion on a recording medium. Improvement in weather fastness is also strongly required because dyes are mainly used as coloring materials. In order to improve these problems, an example where a reaction of a dye ink and a pigment ink is used is proposed (U.S. Pat. No. 5,320,668). However, many improvements are still desired.

### DISCLOSURE OF THE INVENTION

It is an object of the present invention to provide an image recording process, an image recording apparatus and the like, by which weather fastness and fixing ability are improved.

The above object can be achieved by the present invention described below.

According to the present invention, there is thus provided an image recording process for recording an image on a recording medium, which comprises the step of

recording the image on the recording medium with an ink, and

applying a liquid composition comprising an amphiphilic block copolymer and a solvent to at least one of a region in which the image has been recorded with the ink and a region in which no image is recorded with the ink.

The image recording process according to the present invention may comprise applying the liquid composition comprising the amphiphilic block copolymer and the solvent to the region in which no image is recorded with the ink.

The image recording process according to the present invention may comprise applying the liquid composition comprising the amphiphilic block copolymer and the solvent to the region in which the image has been recorded with the ink.

In the image recording process according to the present invention, the critical micelle concentration of the amphiphilic block copolymer may be at most 0.01% by weight.

In the image recording process according to the present invention, the block copolymer may have a repeating unit structure of polyvinyl ether.

In the image recording process according to the present invention, the particle diameter of micelle particles formed by the amphiphilic block polymer may be at most 100 nm.

In the image recording process according to the present invention, the molecular weight distribution, Mw (weight average molecular weight)/Mn (number average molecular weight), of the amphiphilic block polymer may be at most 2.0, and the number average molecular weight Mn may be at least 200.

According to the present invention, there is also provided an image recording apparatus for recording an image on a recording medium, which comprises an applying means for applying a liquid composition by causing energy to act on an ink composition and a liquid composition comprising an amphiphilic block copolymer and a solvent, and a driving means for driving the applying means.

According to the present invention, there is further provided a liquid composition suitable for use in the image recording process and image recording apparatus according to the present invention, which comprises an amphiphilic block copolymer and a solvent.

The liquid composition according to the present invention may contain no coloring material.

According to the present invention, there can be provided an image forming process, by which image-recording properties such as weather fastness, fixing ability and glossiness are improved, and an apparatus and a liquid composition, which are used in this process.

### BRIEF DESCRIPTION OF THE DRAWING

FIG. 1 is a block diagram illustrating the composition of an in ink-jet recording apparatus.

### BEST MODE FOR CARRYING OUT THE INVENTION

1. Ink-Jet Recording Method

With respect to the image recording process according to the present invention, a publicly known method may be partially utilized. In this specification, an ink-jet recording method, which is a preferred embodiment of the present invention, is described. However, the present invention is not limited thereto.

The recording process of the present invention will be described.

The process of the present invention is an image recording process using an ink-jet recording method. The ink-jet recording process comprises recording an image on a recording medium with an ink and then ejecting and applying a liquid composition comprising an amphiphilic block copolymer and a solvent and containing no coloring material.

In the ink-jet recording process, the liquid composition comprising the amphiphilic block copolymer and the solvent may be ejected and applied after or before the image is recorded on the recording medium with the ink.

The ink-jet recording process and apparatus will be first described.

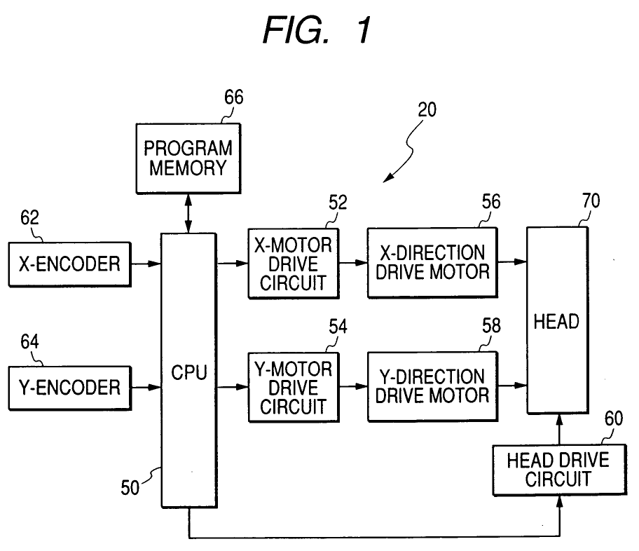

With respect to an ink-jet recording system and apparatus, those publicly known may be used without particular limitation. The ink-jet recording apparatus and recording process will hereinafter be schematically described with reference to FIG. 1. However, the construction shown in FIG. 1 is taken as an example, and the present invention is not limited thereby.

FIG. 1 is a block diagram illustrating the composition of an in ink-jet recording apparatus 20. FIG. 1 illustrates a case where a head is moved to record an image on a recording medium. In FIG. 1, to CPU 50 for controlling the overall operation of the recording apparatus, an X-direction drive motor 56 and a Y-direction drive motor 58 for driving a head 70 to X and Y directions, respectively, are connected through an X-motor drive circuit 52 and a Y-motor drive circuit 54, respectively. The X-direction drive motor 56 and Y-direction drive motor 58 are driven through the X-motor drive circuit 52 and Y-motor drive circuit 54 according to indication by the CPU to determine a position of the head 70 to the recording medium. As shown in FIG. 1, a head drive circuit 60 is connected to the head 70 in addition to the X-direction drive motor 56 and Y-direction drive motor 58. The CPU 50 controls the head drive circuit 60 to drive the head 70, i.e., to eject an ink-jet ink. Further, an X-encoder 62 and a Y-encoder 64 for detecting the position of the head 70 are connected to the CPU 50 to input positional information of the head 70. A control program is stored in a program memory 66. The CPU 50 moves the head 70 on the basis of this control program and the positional information from the X-encoder 62 and Y-encoder 64 to arrange the head at a desired position on the recording medium for ejecting the ink-jet ink. A desired image can be drawn on the recording medium in such a manner. In the case of an image recording apparatus that can be equipped with a plurality of ink-jet inks, predetermined times of the above-described operation are performed, and thereby a desired image can be drawn on the recording medium.

After the ink-jet ink is ejected, the head 70 may also be moved to a position where a removing means (not illustrated) for removing an excessive ink attached to the head is arranged, as needed, to clean the head by wiping or the like. As a specific method for cleaning the head, any conventional method may be used as it is.

After the drawing of the image is completed, the recording medium, on which the image has been drawn, is replaced with a new recording medium by a recording medium-conveying mechanism (not illustrated).

In the present invention, the above-described embodiment may be modified or changed within limits not departing from the subject matter thereof. For example, the head 70 may be moved only to the X direction (or Y direction), and the recording medium may be moved to the Y direction (or X direction) to draw an image while interlocking these movements though the example where the head 70 is moved to both X and Y directions has been described in the above-described embodiment.

In the present invention, a head equipped with a means (for example, electrothermal converter or laser beam) for generating thermal energy as energy used for ejecting the ink-jet ink and ejecting the ink-jet ink by the thermal energy brings about an excellent effect. High definition of the drawing can be achieved according to such a system. Far excellent drawing can be made by using the ink composition for ink-jet of the present invention.

With respect to the typical construction and principle of the apparatus equipped with the means for generating the thermal energy, those using the basic principle disclosed in, for example, U.S. Pat. Nos. 4,723,129 and 4,740,796 are preferred. This system may be applied to any of the so-called On-Demand type and continuous type. In particular, the On-Demand type is effective because at least one driving signal which corresponds to recording information and gives a rapid temperature rise exceeding nuclear boiling is applied to an electrothermal converter arranged corresponding to a liquid path, in which a liquid is retained, thereby causing the electrothermal converter to generate thermal energy to cause film boiling on the heat-acting surface of a head, so that a bubble can be formed in the liquid in response to the driving signal in relation of one to one. The liquid is ejected through an ejection opening by the growth and contraction of this bubble to form at least one droplet. When the driving signal is applied in the form of a pulse, the growth/contraction of the bubble is suitably conducted in a moment, so that the ejection of the liquid, which is excellent in responsiveness in particular, can be achieved. It is therefore preferable to use such pulsed signals. As the pulsed driving signal, such signals as described in U.S. Pat. Nos. 4,463,359 and 4,345,262 are suitable. When the conditions described in U.S. Pat. No. 4,313,124 that discloses an invention relating to the rate of temperature rise on the heat-acting surface are adopted, far excellent ejection can be conducted.

As the construction of the head, such combined constructions (linear liquid flow path or perpendicular liquid flow path) of ejection openings, a liquid flow path and electrothermal converters as disclosed in the above-described publications, and besides constructions based on U.S. Pat. Nos. 4,558,333 and 4,459,600 which disclose the construction that a heat-acting portion is arranged in a curved region may also be included in the present invention. In addition, constructions based on Japanese Patent Application Laid-Open No. S59-123670 which discloses the construction that a slit common to a plurality of electrothermal converters is used as an ejection part of the electrothermal converters, and Japanese Patent Application Laid-Open No. S59-138461 which discloses the construction that an opening which absorbs pressure wave of thermal energy is provided in opposition to an ejection part may also be effective for the present invention. Namely, the ejection of the ink-jet ink can be surely and efficiently conducted according to the present invention even if the head is in any form.

Further, the present invention may also be applied to a full-line type head having a length corresponding to the longest width of recording media. Both construction that the length is satisfied by a combination of plural recording heads and construction of one head integrally formed may be used as such a head.

In addition, the present invention is effective even when among those of the serial type, a head fixed to an apparatus body, or a replaceable chip type head in which electrical connection to the apparatus body and feed of an ink from the apparatus body become feasible by being installed in the apparatus body is used.

Further, the apparatus according to the present invention may additionally have a droplet-removing means. When such a means is equipped, far excellent ejecting effect can be realized.

Moreover, the addition of preliminary auxiliary means, etc., as constitution of the apparatus according to the present invention is preferred because the effects of the present invention can be more stabilized. As specific examples thereof, may be mentioned capping means for the head, pressurizing or sucking means, preliminary heating means for conducting heating by electrothermal converters, other heating elements than these or combinations thereof, and preliminary ejecting means for conducting other ejections than ejection of an ink.

In the present invention, it is most effective to perform the above-described film boiling system.

In the apparatus according to the present invention, the amount of the ink-jet ink ejected from each ejection opening of the ejection head is preferably within a range of from 0.1 pl to 100 pl.

The ink composition of the present invention may also be used in an indirect recording apparatus using, for example, a recording system that an image is formed on an intermediate transfer medium with an ink, and the image is then transferred to a recording medium such as paper. Further, it may be used in an apparatus using an intermediate transfer medium by a direct recording system.

2. Ink Composition

Suitable ink compositions are used for such ink-jet recording process and apparatus as described above, and recording, printing or drawing is conducted by any publicly known method. A coloring material, a solvent and additives are generally contained in the ink compositions. Examples thereof are shown below.

(Coloring Material)

A coloring material such as a pigment or a dye is contained in the ink compositions of the present invention. Any publicly known coloring material may be used as this coloring material.

Specific examples of pigments and dyes used in the ink compositions are mentioned below.

The pigment may be either an organic pigment or an inorganic pigment. As pigments used in inks, may be used black pigments and pigments of three primary colors of cyan, magenta and yellow. Incidentally, other color pigments than those described above, colorless or light-colored pigments and metalescent pigments may also be used. In the present invention, newly synthesized pigments may also be used.

Examples of commercially available pigments in black, cyan, magenta and yellow are mentioned below.

As examples of black pigments, may be mentioned Raven 1060, Raven 1080, Raven 1170, Raven 1200, Raven 1250, Raven 1255, Raven 1500, Raven 2000, Raven 3500, Raven 5250, Raven 5750, Raven 7000, Raven 5000 ULTRA II and Raven 1190 ULTRA II (all, products of Columbian Carbon Co.), Black Pearls L, MOGUL-L, Regal 400R, Regal 660R, Regal 330R, Monarch 800, Monarch 880, Monarch 900, Monarch 1000, Monarch 1300 and Monarch 1400 (all, products of Cabot Company), Color Black FW1, Color Black FW2, Color Black FW200, Color Black 18, Color Black S160, Color Black S170, Special Black 4, Special Black 4A, Special Black 6, Printex 35, Printex U, Printex 140U, Printex V and Printex 140V (all, products of Degussa AG), and No. 25, No. 33, No. 40, No. 47, No. 52, No. 900, No. 2300, MCF-88, MA600, MA7, MA8 and MA100 (all, products of Mitsubishi Chemical Corporation). However, usable black pigments are not limited thereto.

As examples of cyan pigments, may be mentioned C.I. Pigment Blue 1, C.I. Pigment Blue 2, C.I. Pigment Blue 3, C.I. Pigment Blue 15, C.I. Pigment Blue 15:2, C.I. Pigment Blue 15:3, C.I. Pigment Blue 15:4, C.I. Pigment Blue 16, C.I. Pigment Blue 22 and C.I. Pigment Blue 60. However, usable cyan pigments are not limited thereto.

As examples of magenta pigments, may be mentioned C.I. Pigment Red 5, C.I. Pigment Red 7, C.I. Pigment Red 12, C.I. Pigment Red 48, C.I. Pigment Red 48:1, C.I. Pigment Red 57, C.I. Pigment Red 112, C.I. Pigment Red 122, C.I. Pigment Red 123, C.I. Pigment Red 146, C.I. Pigment Red 168, C.I. Pigment Red 184, C.I. Pigment Red 202 and C.I. Pigment Red 207 (all, trade names). However, usable magenta pigments are not limited thereto.

As examples of yellow pigments, may be mentioned C.I. Pigment Yellow 12, C.I. Pigment Yellow 13, C.I. Pigment Yellow 14, C.I. Pigment Yellow 16, C.I. Pigment Yellow 17, C.I. Pigment Yellow 74, C.I. Pigment Yellow 83, C.I. Pigment Yellow 93, C.I. Pigment Yellow 95, C.I. Pigment Yellow 97, C.I. Pigment Yellow 98, C.I. Pigment Yellow 114, C.I. Pigment Yellow 128, C.I. Pigment Yellow 129, C.I. Pigment Yellow 151 and C.I. Pigment Yellow 154 (all, trade names). However, usable yellow pigments are not limited thereto.

Pigments which can be self-dispersed in water may also be used. The pigments which can be self-dispersed in water include those utilizing steric hindrance that a polymer is adsorbed on the surface of a pigment, and those utilizing electrostatic repulsion force. Examples of commercially available products thereof include CAB-O-JET 200 and CAB-O-JET 300 (both, products of Cabot Company), and Microjet Black CW-1 (product of Orient Chemical Industries Ltd.).

When the pigment is used in the ink composition, the amount of the pigment is preferably from 0.1 to 50% by weight based on the weight of the ink composition. If the amount is less than 0.1% by weight, sufficient image density may not be achieved in some cases. If the amount exceeds 50% by weight, the fixing ability of an image formed may be deteriorated in some cases. A more preferable range of the amount is from 0.5% by weight to 30% by weight.

A dye may also be used in place of or in combination of the pigment. Such water-soluble dyes as direct dyes, acid dyes, basic dyes, reactive dyes and food dyes, and insoluble colorants such as disperse dyes, as described below, may be used. As examples of oil-soluble dyes, may be mentioned C.I. Solvent Blue 33, 38, 42, 53, 65, 67, 70, 104, 114, 115 and 135; C.I. Solvent Red 25, 31, 86, 92, 97, 118, 132, 160, 186, 187 and 219; and C.I. Solvent Yellow 1, 49, 62, 74, 79, 82, 83, 89, 90, 120, 121, 151, 153 and 154 (all, trade names).

As examples of water-soluble dyes, may be mentioned

direct dyes such as C.I. Direct Black 17, 62 and 154; C.I. Direct Yellow 12, 87 and 142; C.I. Direct Red 1, 62 and 243; C.I. Direct Blue 6, 78 and 199; C.I. Direct Orange 34 and 60; C.I. Direct Violet 47 and 48; C.I. Direct Brown 109; and C.I. Direct green 59 (all, trade names),

acid dyes such as C.I. Acid Black 2, 52 and 208; C.I. Acid Yellow 11, 29 and 71; C.I. Acid Red 1, 52 and 317; C.I. Acid Blue 9, 93 and 254; C.I. Acid Orange 7 and 19; and C.I. Acid Violet 49 (all, trade names),

reactive dyes such as C.I. Reactive Black 1, 23 and 39; C.I. Reactive Yellow 2, 77 and 163; C.I. Reactive Red 3, 111 and 221; C.I. Reactive Blue 2, 101 and 217; C.I. Reactive Orange 5, 74 and 99; C.I. Reactive Violet 1, 24 and 38; C.I. Reactive Green 5, 15 and 23; and C.I. Reactive Brown 2, 18 and 33 (all, trade names), and

C.I. Basic Black 2; C.I. Basic Red 1, 12 and 27; C.I. Basic Blue 1 and 24; C.I. Basic Violet 7, 14 and 27; and C.I. Food Black 1 and 2 (all, trade names).

When the dye is used in the ink composition, the amount of the dye is preferably from 0.1 to 50% by weight based on the weight of the ink composition.

(Additives)

Various additives and aids may be added to the ink composition as needed. A dispersion stabilizer for dispersing a pigment in a solvent is one of the additives. When dispersion is insufficient, another dispersion stabilizer may also be added.

A resin having both hydrophilic part and hydrophobic part or a surfactant may be used as another dispersion stabilizer. Examples of the resin having both hydrophilic part and hydrophobic part include copolymers of a hydrophilic monomer and a hydrophobic monomer.

Examples of the hydrophilic monomer include acrylic acid, methacrylic acid, maleic acid, fumaric acid, monoesters of the carboxylic acids described above, vinyl alcohol and acrylamide. Examples of the hydrophobic monomer include styrene, styrene derivatives such as α-methylstyrene, vinylcyclohexane, vinylnaphthalene derivatives, acrylic acid esters and methacrylic acid esters. Any of those of various forms such as random, block and graft copolymers may be used as the copolymer. It goes without saying that both hydrophilic monomer and hydrophobic monomer are not limited to those described above.

An anionic, nonionic, cationic or amphoteric surfactant may be used as the surfactant.

Examples of the anionic surfactant include fatty acid salts, alkyl sulfate salts, alkylarylsulfonic acid salts, alkyl diaryl ether disulfonic acid salts, dialkylsulfosuccinic acid salts, alkylphosphonic acid salts, naphthalenesulfonic acid-formalin condensates, polyoxyethylene alkylphosphate salts and glycerol borate fatty acid esters.

Examples of the nonionic surfactant include polyoxyethylene alkyl ethers, polyoxyethylene-oxypropylene block copolymers, sorbitan fatty acid esters, glycerol fatty acid esters, polyoxyethylene fatty acid esters, polyoxyethylenealkylamines, fluorine-containing surfactants and silicon-containing surfactants.

Examples of the cationic surfactant include alkylamine salts, quaternary ammonium salts, alkylpyridinium salts and alkylimidazolinium salts.

Examples of the amphoteric surfactant include alkylbetaines, alkylamine oxides and phosphatidyl choline.

Incidentally, the surfactants are also not limited to those mentioned above.

Besides, a hydrophilic solvent may be added as needed. When the resulting ink composition is used as an ink-jet ink in particular, the hydrophilic solvent is used for the purpose of preventing drying at orifices of the ink and solidification of the ink. Water alone or a mixture of water and the hydrophilic solvent may be used as a solvent.

As the hydrophilic solvent, any of those described above may be used as it is. The content thereof is within a range of from 0.1 to 60% by weight, preferably from 1 to 40% by weight based on the whole weight of the ink.

Examples of other additives that can be added to the ink include pH adjustors for achieving stabilization of the ink and stability of the ink to piping in a recording apparatus; penetrants for accelerating penetration of the ink into a recording medium to facilitate apparent drying; mildewproofing agents for preventing occurrence of mildew in the ink; chelating agents for blocking metal ions in the ink to prevent deposition of metals at a nozzle portion and deposition of insoluble matter in the ink; antifoaming agents for preventing occurrence of foam during circulation, transferring or preparation of the ink; antioxidants; viscosity modifiers; conductivity-imparting agents; and ultraviolet absorbents.

Any other component than those described above may be contained in the ink composition. The ink composition can be prepared by, for example, mixing the above-described components, and uniformly dissolving or dispersing them. For example, the ink composition may be prepared by uniformly mixing a plurality of components in a common solvent, inverting the resultant mixture to a water phase or a non-aqueous phase, dispersing the inverted mixture by a sand mill, ball mill, homogenizer or nanomizer to prepare an ink mother liquor and adding a solvent and additives to this mother liquor to adjust physical properties.

3. Liquid Composition Containing an Amphiphilic Block Copolymer and a Solvent

First, the present invention relates to an ink-jet recording process comprising recording an image with the ink composition described above and then ejecting and applying a liquid composition comprising an amphiphilic block copolymer and a solvent and containing no coloring material. The block copolymer is also called a block polymer. More specifically, the process is a process in which the liquid composition comprising the amphiphilic block copolymer and the solvent and containing no coloring material is applied on to a recording medium, on which the image has been recorded with the ink composition containing a coloring material. As a result, a layer of the amphiphilic block copolymer is formed on the surface of the coloring material. The liquid composition comprising the amphiphilic block copolymer and the solvent and containing no coloring material may be applied in whole or partially. The polymer layer formed by the amphiphilic block copolymer may be uniform or non-uniform, or intermittent.

In the present invention, the polymer layer of the amphiphilic block copolymer formed by the liquid composition comprising the amphiphilic block copolymer and the solvent and containing no coloring material can exhibit functions of protecting the coloring material from external environment. One of them is a function of improving the weather fastness of an image recorded, and another is a function of improving the fixing ability of the coloring material to a recording medium, such as rub-off resistance.

An embodiment of the present invention resides in that the block copolymer is a polymer which forms polymer micelles. A block copolymer which shows a molecule-dissolved state as little as possible, is preferred. More specifically, its critical micelle concentration is preferably at most 0.01% by weight. The critical micelle concentration is more preferably at most 0.001% by weight. The micelle concentration can be determined by observing a critical concentration of a polymer, at which a solvophobic substance is dispersed, or likewise observing a critical concentration of a polymer, at which micelle particles are formed, by dynamic light scattering. Those having a relatively high molecular weight of their solvophobic segment are preferred, which show as little molecularly dissolved polymers as possible, and which are preferred for forming polymer micelles. More specifically, it is preferable that the number of repeating units be at least 20, and the number average molecular weight be at least 5,000. It is more preferable that the number of repeating units be at least 40, and the number average molecular weight be at least 8,000. The number average molecular weight can be measured by gel permeation chromatography.

The block copolymer that is a component characteristically used in the present invention will now be described. Specific examples thereof include acrylic or methacrylic block polymers, block copolymers composed of polystyrene and another addition polymerization system or condensation polymerization system, and block copolymers having blocks of polyoxyethylene and polyoxyalkylene. Any of well known block copolymers such as sodium polystyrene acrylate, copolymers of methyl methacrylate and potassium acrylate, and polystyrene polyethylene glycol may be used. The block copolymer is more preferably in a block form of AB, ABA, ABD or the like, in which A, B and D indicate block segments different from one another.

No particular limitation is imposed on the ratio of an amphiphilic block. However, it is preferably from 1:100 to 100:1, more preferably from 1:9 to 9:1 in terms of a molar ratio.

In the present invention, the block polymer may be a graft polymer bonded in a T-shaped form to a certain polymer chain. Each segment of the block copolymer may be a copolymer segment, and the copolymer form thereof may be, for example, a random segment or graduation segment.

In the present invention, a polymer having a low glass transition point is preferably used from the viewpoint of adhesion to a recording medium. Such a polymer is a polymer having a glass transition temperature of preferably at most 25° C., more preferably at most 0° C.

In the present invention, a block copolymer containing a polyalkenyl ether structure is preferably used. A block copolymer composed of polyalkenyl ether generally has a low glass transition temperature. The glass transition temperature may amount to −20° C. or lower in some cases. Therefore, such a block copolymer is preferably used. A block copolymer containing a polyvinyl ether structure is particularly preferred. A block copolymer composed of the polyvinyl ether structure is preferably used because it generally has a low glass transition temperature and from the viewpoints of the critical micelle concentration and development of good amphiphilic property in that a minute block copolymer is formed by using a polymerization process, which will be described subsequently. Many synthesizing processes for a (co)polymer containing a polyalkenyl ether structure preferably used in the present invention have been reported (for example, Japanese Patent Application Laid-Open No. H11-080221). A process by cationic living polymerization by Aoshima (Japanese Patent Application Laid-Open Nos. H11-322942 and H11-322866), et al. is representative thereof. By conducting polymer synthesis by the cationic living polymerization, various polymers such as homopolymers, copolymers composed of two or more monomers, block polymers, graft polymers and graduation polymers can be synthesized with their chain lengths (molecular weights) exactly made uniform. Further, in the polyalkenyl ether, various functional groups can be introduced into side chains thereof. Besides, the cationic polymerization process may be conducted in an HI/I₂ system, HCl/SnCl₄ system or the like.

The structure of the block polymer containing the polyalkenyl ether structure may be a copolymer composed of vinyl ether and another polymer. However, a block copolymer composed of the polyalkenyl ether or polyvinyl ether structure is preferred.

The block polymer containing the polyvinyl ether structure preferably used in the present invention preferably has a repeating unit structure represented by the following general formula (1)
—(CH₂—CH (OR¹)) (1)
wherein R¹ is selected from a linear, branched or cyclic alkyl group having 1 to 18 carbon atoms, —(CH(R²)—CH(R³)—O)₁—R⁴ and —(CH₂)ₘ—(O)ₙ—R⁴, in which m is an integer of from 1 to 12, n is 1 or 0, R² and R³ are, independently of each other, hydrogen or CH₃, and R⁴ is a linear, branched or cyclic alkyl group having 1 to 6 carbon atoms, Ph, Pyr, Ph-Ph, Ph-Pyr, —CHO, —CH₂CHO, —CO-CH═CH₂, —CO—C (CH₃)═CH₂ or —CH₂COOR⁵, with the proviso that hydrogen bonded to carbon may be substituted by a linear or branched alkyl group having 1 to 4 carbon atoms, F, Cl or Br, and carbon in the aromatic ring may be substituted by nitrogen, and R⁵ is an alkyl group having 1 to 5 carbon atoms.

In the present invention, -Ph, -Pyr, -Ph-Ph and -Ph-Pyr denote phenyl, pyridyl, biphenyl and pyridylphenyl groups, respectively. With respect to the pyridyl, biphenyl and pyridylphenyl groups, they may be any position isomers.

In the present invention, the amphiphilic block copolymer is used. Such a block copolymer can be obtained by, for example, selecting a solvophobic block segment and a solvophilic block segment from the repeating unit structures of the general formulae (1) and synthesizing them. In the case of the graft polymer, an amphiphilic polymer can be obtained by, for example, grafting a hydrophobic polymer segment on a solvophilic polymer. Water is an example of a preferable medium.

The molecular weight distribution Mw (weight average molecular weight)/Mn (number average molecular weight) of the block polymer used in the present invention is preferably at most 2.0, more preferably at most 1.6, still more preferably at most 1.3.

The number average molecular weight Mn of the block polymer used in the present invention is preferably at least 200, preferably at least 3,000, but preferably does not exceed 1,000,000. If the number average molecular weight is lower than 200, the dispersion stability of a functional substance may be deteriorated in some cases. In the present invention, the number average molecular weight and weight average molecular weight of a polymer can be measured by volume exclusion chromatography (another name: gel permeation chromatography (GPC)). The content of the block copolymer used in the composition according to the present invention is from 0.1% by weight to 90% by weight, preferably from 1% by weight to 50% by weight based on the weight of the composition according to the present invention. If the content is lower than 0.1% by weight, the functional substance may not be sufficiently dispersed in some cases. If the content exceeds 90% by weight, the viscosity of the resulting composition may become too high in some cases.

In the present invention, the amphiphilic block copolymer is characteristically used. In the present invention, the amphiphilic block copolymer may preferably form micelles. By forming the micelle, a relatively low viscosity suitable for ink-jet ejection can be realized at a certain polymer concentration. The water resistance of a recording medium may also be improved by the hydrophobic segment.

The size of micelle particles formed from the amphiphilic block copolymer is preferably 100 nm or less. Excessively large particle sizes may lead to excessively high viscosity of the composition in some cases.

The composition according to the present invention contains a solvent. No particular limitation is imposed on the solvent contained in the composition according to the present invention. The solvent means a medium that can dissolve, suspend or disperse components contained in the ink composition therein. In the present invention, organic solvents such as various kinds of linear, branched and cyclic aliphatic hydrocarbons, aromatic hydrocarbons, and heterocyclic aromatic hydrocarbons, hydrophilic solvents, water, and the like may be used as the solvent. It goes without saying that mixed solvents thereof may also be used.

In particular, water and hydrophilic solvents may be suitably used in the composition according to the present invention.

Examples of the hydrophilic solvents include polyhydric alcohols such as ethylene glycol, diethylene glycol, triethylene glycol, polyethylene glycol, propylene glycol, polypropylene glycol and glycerol, ethers of polyhydric alcohols, such as ethylene glycol monomethyl ether, ethylene glycol monoethyl ether, ethylene glycol monobutyl ether, diethylene glycol monoethyl ether and diethylene glycol monobutyl ether, and nitrogen-containing solvents such as N-methyl-2-pyrrolidone, substituted pyrrolidone and triethanolamine. Monohydric alcohols such as methanol, ethanol and isopropanol may also be used. With respect to the pH of water, the composition may be used in an overall pH range. However, the pH is preferably from 1 to 14. The content of the solvent used in the present invention is from 1% by weight to 99% by weight, preferably from 10% by weight to 99% by weight. If the content is lower than 1% by weight, the viscosity of the resulting composition may become too high in some cases. If the content exceeds 99% by weight, the function of the functional substance may not be sufficiently exhibited in some cases.

Besides the above components, additives such as antioxidants, viscosity reducing agents, ultraviolet absorbents, surfactants and mildewproofing agents may be added to the composition according to the present invention the present invention.

Second, the present invention relates to an ink-jet recording apparatus. The apparatus illustrated in FIG. 1 may be mentioned as a specific example thereof. The apparatus can be applied to various ink-jet recording apparatus such as a piezo ink-jet system using a piezoelectric element and a thermal ink-jet system that thermal energy is applied to an ink to bubble the ink.

The present invention will hereinafter be described in detail by the following examples. However, the present invention is not limited to these examples.

### EXAMPLE 1

An ink-jet printer (BJC-600, trade name, manufactured by Canon Inc.) was used to make tests. After printing was conducted with a magenta ink, the following block polymer (AB block polymer composed of isobutyl vinyl ether (IBVE; block A component) and sodium 4-(2-vinyloxyethoxy)benzoate (block B component); polymerization ratio A/B=200/30; number average molecular weight: 35,000, weight average molecular weight: 43,200 (identified by means of NMR and GPC)) was used to add 5 parts by mass of the block polymer and 15 parts by mass of diethylene glycol to 250 parts by mass of ion-exchanged water. The pH of the resultant mixture was adjusted to 9, and the mixture was subjected to a dispersion treatment by means of an ultrasonic homogenizer. The thus-treated mixture was filtered under pressure through a filter having a pore size of 1 μm. A composition thus prepared was charged into a vacant ink tank, and printing was conducted to overprint the same pattern as that of the magenta ink thereon. The viscosity of this composition was measured by a viscoelastometer manufactured by Rheologica Co. and was found to be 3.9 cp.

After 5 minutes elapsed from the printing, the printed area was strongly rubbed twice with a line marker. As a result, no smeared image trailing edge of the magenta color appeared. The retention of optical density (OD) of the printed area after 1 week was 98.2%.

After 3 minutes from the recording, 10 cc of distilled water was dropped on the recording medium. As a result, no bleeding occurred.

The block polymer composition was diluted in such a manner that the concentration of the block polymer amounts to 0.0005% by weight, and formation of particles was observed by means of a dynamic light-scattering apparatus (DLS-7000, trade name; manufactured by Otsuka Electronics Co., Ltd.). As a result, polymer micelles having an average particle diameter of 94 nm was observed. At the same time, its critical micelle concentration both in water and the above mixed solvent was found to be 0.0005% by weight or lower.

### EXAMPLE 2

The polymer used in EXAMPLE 1 was changed to an AB block polymer (polymerization ratio A/B=100/30; number average molecular weight: 15,000, weight average molecular weight: 22,200 (identified by means of NMR and GPC)) composed of a 50:50 random copolymer (block A segment) of (2-biphenyloxyethyl vinyl ether and isobutyl vinyl ether and sodium 4-(2-vinyloxyethoxy)benzoate (block B segment) to make the same test as in EXAMPLE 1. After 5 minutes elapsed from the printing, the printed area was strongly rubbed twice with a line marker. As a result, no smeared image trailing edge of the magenta color appeared. The retention of optical density (OD) of the printed area after 1 week was 97.5%.

The block polymer composition was diluted in such a manner that the concentration of the block polymer amounts to 0.0005% by weight, and formation of particles was observed by means of a dynamic light-scattering apparatus (DLS-7000, trade name; manufactured by Otsuka Electronics Co., Ltd.). As a result, polymer micelles having an average particle diameter of 64 nm was observed. At the same time, its critical micelle concentration both in water and the above mixed solvent was found to be 0.0005% by weight or lower.

### COMPARATIVE EXAMPLE 1

The test by the ink-jet printer BJC-600 in EXAMPLE 1 was made except that the block polymer composition was not applied after the printing with the magenta ink. After 5 minutes elapsed from the printing, the printed area was strongly rubbed twice with a line marker. As a result, a smeared image trailing edge of the magenta color appeared. The retention of optical density (OD) of the printed area after 1 week was 88.1%.

### COMPARATIVE EXAMPLE 2

Polyvinyl alcohol, which was a water-soluble polymer and had a number average molecular weight of 15,000, was used in place of the amphiphilic block copolymer to prepare a composition to be applied after the recording with the ink. The viscosity of this composition was measured by a viscoelastometer manufactured by Rheologica Co. and was found to be 36.9 cp. The polymer concentration was seven times diluted to adjust the composition. As a result, the viscosity thereof was 6.2 cp. The composition was charged into a vacant ink tank after conducting recording in the same manner as in EXAMPLE 1, and printing was conducted to overprint the same pattern as that of the magenta ink thereon. After 3 minutes from the recording, 10 cc of distilled water was dropped on the recording medium. As a result, bleeding occurred intensely.

### EXAMPLE 3

Five parts by weight of the block copolymer used in EXAMPLE 1 and 3 parts by weight of Pigment Blue 15:3 were dispersed in 20 parts by weight of DMF by means of an ultrasonic dispersing device, and 70 parts by weight of purified water was gradually added to obtain a dispersion of the cyan pigment. To this dispersion were added 15 parts by weight of diethylene glycol and 5 parts by weight of glycerol, thereby preparing an ink composition. This cyan ink was used to record on glossy paper PR101 (trade name, product of Canon Inc.) a vertical line pattern having a line width of 2 mm with a space of 2 mm between lines in an 8-cm square by means of the same ink-jet printer as that used in EXAMPLE 1. The composition used in EXAMPLE 1, which contained no coloring material and contained the block copolymer, was applied to all space portions 2 mm wide in the 8-cm square where no cyan ink was applied. The gloss of the print thus obtained was measured from a direction of 20° with respect to the direction of the vertical lines by means of a gloss meter. The measurement was conducted at 50 points while shifting the recording medium 1 mm by 1 mm. As a result, a difference of the gloss values were within 7%.

### COMPARATIVE EXAMPLE 3

Five parts by weight of the block copolymer used in EXAMPLE 1 and 3 parts by weight of Pigment Blue 15:3 were dispersed in 20 parts by weight of DMF by means of an ultrasonic dispersing device, and 70 parts by weight of purified water was gradually added to obtain a dispersion of the cyan pigment. To this dispersion were added 15 parts by weight of diethylene glycol and 5 parts by weight of glycerol, thereby preparing an ink composition. This cyan ink was used to record on glossy paper PR101 (trade name, product of Canon Inc.) a vertical line pattern having a line width of 2 mm with a space of 2 mm between lines in an 8-cm square by means of the same ink-jet printer as that used in EXAMPLE 1. The recording medium was shifted by 1 mm to measure gloss at each one point of a portion where the cyan ink was applied and a portion where no cyan ink was applied. A difference between their gloss values was 32%.

This application claims priorities from Japanese Patent Applictions No. 2003-335855 filed on Sep. 26, 2003 and No. 2004-266981 filed on Sep. 14, 2004, which are hereby incorporated by reference herein.

1. An image recording process for recording an image on a recording medium, which comprises the step of:
recording the image on the recording medium with an ink; and
applying a liquid composition comprising an amphiphilic block copolymer and a solvent to at least one of a region, in which the image has been recorded with the ink and a region in which no image is recorded with the ink.

2. The image recording process according to claim 1, wherein the liquid composition comprising the amphiphilic block copolymer and the solvent is applied to the region in which no image is recorded with the ink.

3. The image recording process according to claim 1, wherein the liquid composition comprising the amphiphilic block copolymer and the solvent is applied to the region in which the image has been recorded with the ink.

4. The image recording process according to claim 1, wherein the amphiphilic block copolymer has a critical micelle concentration of at most 0.01% by weight.

5. The image recording process according to claim 1, wherein the block copolymer has a repeating unit structure of polyvinyl ether.

6. The image recording process according to claim 1, wherein the amphiphilic block polymer forms micelle particles having a particle diameter of at most 100 nm.

7. The image recording process according to claim 1, wherein the amphiphilic block polymer has a molecular weight distribution Mw (weight average molecular weight)/Mn (number average molecular weight) of at most 2.0.

8. The image recording process according to claim 1, wherein the number average molecular weight Mn is at least 200.

9. An image recording apparatus for recording an image on a recording medium, which comprises an applying means for applying a liquid composition by causing energy to act on an ink composition and a liquid composition comprising an amphiphilic block copolymer and a solvent, and a driving means for driving the applying means.

10. A liquid composition suitable for use in the image recording process according to claim 1, which comprises an amphiphilic block copolymer and a solvent.

11. The liquid composition according to claim 10, which contains no coloring material.

12. A liquid composition suitable for use in the image recording apparatus according to claim 9, which comprises an amphiphilic block copolymer and a solvent.

13. The liquid composition according to claim 12, which contains no coloring material.
